(19) United States
(12) Patent Application Publication
(10) Pub. No.: US 2024/0251787 A1
(43) Pub. Date: Aug. 1, 2024

(54) AGROCHEMICAL COMPOSITION, AGROCHEMICAL FORMULATION, USE OF A DIOXABICYCLOALKANE DERIVATIVE, AND, METHOD FOR THE TREATMENT AND/OR PREVENTION OF DISEASES OR PESTS IN A PLANT OR PLANT SEED

(71) Applicant: Oxiteno S.A. Indústria e Comércio, São Paulo (BR)

(72) Inventors: Rafael Augusto Alves FERREIRA, Mauá SP (BR); Rafael PIRES-OLIVEIRA, Mauá São Paulo (BR); Poliana CARDOSO-GUSTAVSON, Mauá SP (BR); Bruna MENDONÇA, Mauá São Paulo (BR); Heloisa GONÇALVES, Mauá SP (BR); Mariana MARTINS REIS ANDRADE, Mauá São Paulo (BR)

(73) Assignee: Oxiteno S.A. Indústria e Comércio, São Paulo (BR)

(21) Appl. No.: 18/560,432

(22) PCT Filed: May 11, 2022
(86) PCT No.: PCT/BR2022/050161

§ 371 Date: Nov. 13, 2023

(30) Foreign Application Priority Data
May 12, 2021 (BR) 1020210092483

(51) Int. Cl. A01N 25/30; A01N 25/04; A01N 41/10; A01N 43/50; A01N 43/54; A01N 43/653; A01N 43/80; A01P 3/00; A01P 5/00; A01P 7/04; A01P 13/00; A01P 21/00

(52) U.S. Cl. CPC A01N 25/30; A01N 25/04; A01N 41/10; A01N 43/50; A01N 43/54; A01N 43/653; A01N 43/80; A01P 3/00; A01P 5/00; A01P 7/04; A01P 13/00; A01P 21/00

(57) ABSTRACT

The present disclosure describes an agrochemical composition comprising at least one pesticidal active ingredient and a solvent based on a dioxabicycloalkane derivative, as well as an agrochemical formulation comprising said composition. Additionally, the present disclosure also describes the use of a dioxabicycloalkane derivative and a method for treating and/or preventing diseases or pests in a plant or plant seed.

### FIELD OF THE INVENTION

The present disclosure is related to a composition comprising a solvent derived from renewable sources with an excellent toxicological profile and to an agrochemical formulation comprising said composition.

Additionally, the present disclosure also relates to the use of said solvent derived from renewable sources in agriculture enhancing the uptake and penetration of active ingredients and to a method for treating or preventing diseases or pests in a plant or plant seed without causing phytotoxicity to crops cultivated.

### FUNDAMENTALS OF THE INVENTION

Agrochemical compositions and formulations are usually composed of active ingredient(s) and inert compounds that enhance the effects of active ingredients and/or facilitate their application. Inert compounds include carrier solvents, diluents, surfactants, stabilizers, among others.

The type of formulation to be chosen is directly related to the physicochemical characteristics of the active ingredients, and can be of the following types: soluble concentrate (SL), emulsifiable concentrate (EC), concentrated aqueous emulsion (EW), suspension concentrate (SC), suspension concentrate for seed treatment (FS), suspoemulsion (SE), microemulsion (ME), dispersion or suspension in oil (OD), dispersible concentrate (DC), capsule suspension (CS), mixture of CS and SC (ZC), mixture of CS and EW (ZW), mixture of CS and SE (ZE), dispersible granule (WG), wettable powder (WP), among others (standard ABNT NBR 12679:2018—Pesticides and related products, Technical and formulations, terminology).

Thus, the different types of agrochemical formulations have the function of facilitating the handling or application of the active ingredient, as these generally do not mix well with water. In addition, they must ensure improved safety for the user and the environment in terms of toxicity and stability, as well as increasing efficiency in agriculture by making the active ingredient more available to pests.

Considering that most of the active ingredients are insoluble in water, it is common to use organic solvents in agrochemical compositions. These compositions comprising organic solvents are known as oil-based formulations and are very relevant in the agrochemical market.

However, many of the organic solvents currently used, not only in agriculture, but also in other areas, come from petroleum and have high levels of naphthalene compounds, which are generally associated with high toxicity.

One of the most common solvents is N-methyl-pyrrolidone (NMP), which has a high solvency capacity. However, this solvent presents, for example, toxicity to the reproductive system, which can harm the fetus, which leads to a progressive decrease in its use.

As a renewable alternative to NMP, N,N-dimethyldecanamide is another solvent commonly used in the agrochemical market with a certain solvency capacity and better toxicological profile when compared to NMP, however, an important negative point of this solvent is the promotion of injuries in crops, something undesirable for agrochemical formulations.

In order to overcome the problem of toxicity of organic solvents from petroleum, it is possible to notice a great increase in the interest, in different areas, in the development of solvents from renewable sources, which are biodegradable, have a mild toxicological and ecotoxicological profile and which still the same or similar solvency power to that of petrochemical-based solvents.

Another requirement of solvents used in agrochemical formulations of the EC, EW, ME, SE, and OD types is their low water solubility, due to the low solubility of active ingredients in water. When a solution containing an active ingredient and a water-miscible solvent is diluted in water, diffusion of the solvent into the aqueous medium can occur and, thus, the active ingredient undergoes crystallization, becomes unavailable for biological activity, and can lead to blockage of parts of spraying equipment.

In agriculture, for example, it is possible to find both patent documents and scientific journals aimed at the development of solvents derived from renewable sources for application in agrochemical formulations.

The document “New Solvents for Agrochemical Formulations—A Green Chemistry Approach”, by authors F. B. Costa and A. S. de Oliveira (2015) describes new ester solvents based on citric acid and branched alcohols derived from sugarcane, in addition to EC formulations comprising such solvents.

The patent document PCT/EP2018/062165 describes the use of lactone derivatives as solvents in agrochemical formulations and, from the state of the art, it is known that different lactone derivatives can be obtained from renewable sources, such as caprolactones.

In the area of polymers, in turn, it is also possible to verify the growing development of solvents derived from natural sources. In general, polymers are synthesized and/or solubilized in a solvent system containing organic solvents with a high degree of toxicity and/or flammability, such as, for example, acetone, ethanol, dichloromethane, aromatics, and paraffinic.

One use of volatile or water-miscible solvents is the controlled precipitation of water-insoluble polymers when their solution in this organic solvent is diluted in water or after its volatilization. In this way, the polymer is precipitated at the interface of the discontinuous phase, which contains the water-immiscible solvent system containing the active ingredient, and of the continuous phase, water. PCT/IB2011/000626 describes the process of controlled precipitation of polymers using the solvents methanol, ethanol, ethyl acetate, isopropanol, methoxy propanol, butanol, DMSO, dioxane, DMF, NMP, THF, acetone, dichloromethane, toluene, or mixtures thereof, either by evaporating the solvent or by mixing it with water, altering the solvent environment of the polymer and rendering it insoluble in the medium and leading to its precipitation. All these solvents have a degree of toxicity and/or flammability that reduce their safety in use.

PCT/EP2016/070751 (WO2017050541) describes the use of cellulose derivatives as solvents in the preparation of polyamidoimide polymer, as well as coating compositions for metallic surfaces comprising said polymer. More precisely, the cellulose derivatives used in PCT/EP2016/070751 are dioxabicycloalkane derivatives.

Recently, the potential of dioxabicycloalkane derivatives as renewable solvents for synthesis reactions in the pharmaceutical industry has also been observed.

The article published in Green Chem. 2019, 21, 3675 brings the synthesis of amides from acid chloride and amines using a specific dioxabicycloalkane derivative, namely 6,8-dioxabicyclo[3.2.1]octan-4-one or dihydrolevoglucosenone as a solvent. The coupling reaction to form amides is one of the most common reactions for drug synthesis.

The article published in Green Chem. 2017, 19, 2123 reports the synthesis of ureas using dihydrolevoglucosenone as a solvent, also highlighting a benefit of its use in efficiency compared to industrial processes.

In this sense, the present disclosure seeks to develop new solutions comprising cellulose-derived solvents for use in agrochemical compositions and formulations, maintaining the solvency capacity observed for petrochemical-based solvents, improving the toxicological/ecotoxicological profile and that do not cause phytotoxicity in crops.

It was surprisingly found that dioxabicycloalkanes derivatives are able to act as a carrier solvent for active ingredients in agrochemical compositions/formulations, providing excellent results in combating pests in 10 agriculture.

The dioxabicycloalkane derivatives have excellent toxicological profiles, with only eye irritation being observed, which is commonly observed for the main market solvents, however no other toxicity classifications were observed.

Commonly market solvents cause injuries to cultures, as is the case of N,N-dimethyldecanamide and N-methyl pyrrolidone, however the dioxabicycloalkanes derivatives have no phytotoxicity in cultures, evidencing the safety of dioxabicycloalkanes derivatives for cultures.

The use of encapsulated formulations for the controlled release of agrochemical actives has become relevant and has been described for some years in the state of the art, and among the advantages it brings the sustainable appeal achieved by the dose reduction and the safety to the applicator, by the protection of the active. However, it still presents technical challenges and requires improvements. One of the points of improvement is in the solvent to be used in the encapsulation process. Both in older patent documents, such as PCT/US1988/000207, and in more recent ones, such as PCT/US2019/060981, it is possible to note the presence of aromatic solvents and petrochemical derivatives, which do not have a friendly toxicological and ecotoxicological profile.

Considering that dioxabicycloalkanes derivatives are molecules of high polarity (as exemplified by the representative dihydrolevoglucosenone, which has a partition coefficient value between 1-octanol/water, log P, equal to −1.52) and that polar solvents miscible with water frequently show active ingredient crystallization upon dilution in water, it was surprisingly observed that solutions of water-insoluble active ingredients prepared in dioxabicycloalkanes derivatives do not show immediate crystallization of the active ingredient, so the time in which the solution remains biphasic can be suitable for processes production of “oil-based” formulations.

Additionally, besides the carrier solvent function, the present invention unexpectedly found that dioxabicycloalkane derivatives can also act as a promoter of active ingredient penetration in plant parts or as a solvent or co-solvent in polymeric encapsulation systems.

### SUMMARY OF THE INVENTION

The present disclosure is related to an agrochemical composition comprising at least one pesticidal active ingredient and a solvent based on a dioxabicycloalkane derivative.

A second objective of the present disclosure is to provide an agrochemical formulation comprising said composition, wherein the agrochemical formulation may be present in different forms of presentation and concentrations.

A third objective of the present disclosure is the use of a dioxabicycloalkane derivative in agriculture.

Furthermore, the present disclosure also describes a method for treating and/or preventing diseases or pests in a plant or plant seed.

These objectives and other advantages of the present disclosure will be more evident from the description that follows.

### BRIEF DESCRIPTION OF THE FIGURES

FIG. 1 shows four vials that were used for diluting a solution of the ingredient azoxystrobin in four different solvents with varying polarities in water in a ratio of 1:20 (solution:water). Bottle A contains the solvent dihydrolevoglucosenone, B contains γ-butyrolactone, C contains N-methylpyrrolidone and D contains triacetin.

FIG. 2 shows a representative image of the phytotoxicity tests performed on plants of the species Euphorbia pulcherrima (Euphorbiaceae)—also known as Poinsettia.

FIG. 3 shows a microscopy image of the agrochemical formulation of the present invention in capsule form.

FIG. 4 shows a graph containing the chlorophyll fluorescence results of a plant leaf of the species Euphorbia heterophylla (Euphorbiaceae), when applying agrochemical formulations containing dihydrolevoglucosenone and a commercially available mesotrione formulation for comparison purposes.

### DETAILED DESCRIPTION OF THE INVENTION

The present disclosure relates to an agrochemical composition comprising:
i) at least one pesticidal active ingredient; and
ii) a solvent based on a dioxabicycloalkane derivative.

Compounds derived from dioxabicycloalkanes are polar compounds that can be obtained from wood or other cellulose-containing materials and are readily biodegradable.

In the present disclosure, a dioxabicycloalkane derivative is understood to mean any compound selected from the group comprising a dioxabicyclo[3.2.1]octane, dioxabicyclo[3.3.2]decane, dioxabicyclo[4.3.1]decane, dioxabicyclo[3.3.3]undecane, dioxabicyclo[2.2.2]octane, dioxabicyclo[4.2.2]decane, dioxabicyclo[5.2.1]decane, dioxabicyclo[4.3.2]undecane, dioxabicyclo[4.4.1]undecane, dioxabicyclo[5.3.1]undecane, or their derivatives or mixtures thereof.

In a preferred embodiment, the dioxabicycloalkane derivative is a dioxabicyclo[3.2.1]octane derivative selected from the group comprising 2,8-dioxabicyclo[3.2.1]octane, 2,8-dioxabicyclo[3.2.1]octan-4-one, 2,8-dioxabicyclo[3.2.1]octan-4-thione, 4-methylidene-2,8-dioxabicyclo[3.2.1]octane, 1-methyl-2,8-dioxabicyclo[3.2.1]octan-7-one, 1,4,4-trimethyl-2,8-dioxabicyclo[3.2.1]octan-7-one, 1,3,5-trimethyl-2,8-dioxabicyclo[3.2.1]octan-7-one, 1-methyl-4-phenyl-2,8-dioxabicyclo[3.2.1]octan-7-one, 1-methyl-4-phenyl-2,8-dioxabicyclo[3.2.1]oct-7-yl acetate, 6,8-dioxabicyclo[3.2.1]octane, 6,8-dioxabicyclo[3.2.1]octan-4-thione or 6,8-dioxabicyclo[3.2.1]octan-4-one or mixtures thereof.

More preferably, the dioxabicycloalkane derivative employed in the agrochemical composition of the present dislcosure is 6,8-dioxabicyclo[3.2.1]octan-4-one, or dihydrolevoglucosenone.

The at least one pesticidal active ingredient may be selected from the group comprising, but not limited to, herbicides, fungicides, insecticides, nematicides, plant growth regulators, and phytotoxicity reducers.

In the embodiment in which at least one pesticide active ingredient is a herbicide, the classification according to the Herbicide Resistance Action Committee (HRAC-BR) in relation to chemical classes, namely: acetamides, acid arylaminopropionic acid, benzoic acid, chlorocarbonic acid, phenoxycarboxylic acid, phosphinic acid, quinoline carboxylic acid, amides, aryloxyphenoxypropionates (FOPs), arylpicolinate, benzamides, benzofurans, benzothiadiazinones, bipyridyliums, carbamates, cyclohexanediones (DIMs), chloroacetamides (V1), chloroacetamides (V2), chloroacetamides (V3), diphenyl ethers, dinitroanilines, dinitrophenols, phenyl-carbamates, phenylpyrazoles, phenylpyrazolines (DENs), phenyl-pyridazines, phosphoroamidates, phosphorodithioates, phthalamates, semicarbazones, glycines, imidazolinones, long-chain fatty acid inhibitor, isoxazoles, isoxazolidinones, N-phenylphthalimides, nitriles, organoarsenicals, oxadiazoles, oxazolidinediones, oxyacetamides, pyrazoles, pyrazole ions, pyridazinones, pyridines, pyridinecarboxamides, pyrimidindiones, pyrimidinyl(thio)benzoates, sulfonylaminocarbonyl-triazolinones, sulfonylureas, tetrazolinones, thiadiazoles, thiocarbamates, triazines, triazinones, triazoles, triazolinones, triazolocarboxamides, triazolopyrimidines, triketones, uracils, ureas or the like.

In the embodiment in which the at least one pesticidal active ingredient is a fungicide, the classification according to the Brazilian Fungicide Resistance Action Committee (FRAC-BR) in relation to chemical classes was used as a definition, namely: 1,2,4-thiadiazole, 2,6-dinitro-aniline, 4-quinolyl-acetate, carboxylic acid, enopyranuronic acid, phthalamic acid, acylalanine, allylamine, mandelic acid amides, cinnamic acid amides, aminocyanoacrylate, amino-pyrazolinone, anilinopyrimidine, anthraquinone, aryloxyquinoline, Bacillus sp. and the fungicide lipopeptides produced, benzenesulfonamide, benzylcarbamate, benzimidazole, benzisothiazole, benzophenone, benzoylpyridine, benzothiadiazole BTH, benzotriazine, butyrolactone, carbamate, carboxamide, cyanoacetamide-oxime, cyano-imidazole, cyano-methylene-thiazolidine, cyclopropane carboxamide, chloronitrile, triphenyltin compounds, dicarboximide, dihydro-dioxazine, dinitrophenyl crotonate, dithiocarbamates and relatives, dithiolane, spiroketal-amine, ethyl phosphonate, ethylamino-thiazole-carboxamide, phenyl-acetamide, phenyl-benzamide, phenyl-oxo-ethyl thiophene amide, phenylpyrrole, phenylurea, phosphonate, phosphorothiolate, phthalimide, furan-carboxamide, guanidine, aromatic hydrocarbon, terpenic hydrocarbons and terpenic alcohols, hydroxy-(2-amino-)pyrimidine, hydroxyaniline, imidazole, imidazolinone, inorganic (copper), inorganic (sulfur), isobenzofuranone, isothiazolone, isoxazole, maleimide, methoxy-acetamide, methoxy-acrylate, methoxy-carbamate, Reynoutria sp. extract, morpholine, N-phenyl carbamate, N-methoxy-(phenyl-ethyl)-pyrazole-carboxamide, peptidyl pyrimidine nucleoside, oxatin-carboxamide, oxazolidine-dione, oxazolidinone, oximino-acetamide, oximino-acetate, piperazine, piperidine, piperidinyl-thiazole-isoxazoline, pyrazole-4-carboxamide, pyrazole-5-carboxamide, pyridazinone, pyridine, pyridine-carboxamide, pyridinyl-ethyl benzamide, pyridinylmethyl-benzamide, pyrimidine, pyrimidinamine, pyrimidinone-hydrazone, pyrrolo-quinolinone, polypeptide (lectin), polysaccharide, propionamide, quinazolinone, quinoxaline, sulfamoyl-triazole, sulfonamide, tetrazoyloxime, thiadiazole-carboxamide, thiazole-carboxamide, thiocarbamate, thiophanate, thiophene-carboxamide, toluamide, triazine, triazole, triazolinthione, triazolobenzothiazole, triazole-pyrimidylamine, Trichoderma sp. and fungicidal metabolites produced, trifluoroethylcarbamate, valinamide carbamate or the like.

In the embodiment in which the at least one pesticide active ingredient is an insecticide, the classification according to the Brazilian Insecticide Resistance Action Committee (IRAC-BR) in relation to chemical classes was used as a definition, namely: group of METI acaricides and insecticides, acequinocil, halogenated aliphatic, amitraz, nereistoxin analogues, juvenile hormone analogues, avermectins, milbemycins, azadirachtin, Bacillus sp. and produced insecticidal proteins, benzoylureas, benzoximate, biphenazate, borates, borax, bromopropylate, buprofezin, butenolides, sulfocalcium syrup, carbamates, carboxanilides, cyanides, cyclodienes, cyromazine, clofentezine, diflovidazin, hexithiazoxy, chlorfenapyr, dinitrophenol, sulfluramid, chloropicrin, DDT methoxychlor, tetronic and tetramic acid derivatives, beta-ketonitrile derivatives, azomethine pyridine derivatives, diacylhydrazines, diafenthiuron, diamides, dicofol, spinosyns, ethoxazole, phenylpyrazoles (fiproles), phenoxycarb, saponin flavones of the rotenoid type, flonicamide, fluacripyrim, fluorides, phosphides, methyl isothiocyanate generators, hydramethylnonone, inorganic, inorganic phosphine precursor, methyl isothiocyanate precursor, organophosphate, mesoionic, neonicotinoid, nicotine, organotin, organophosphate, oxadiazines, GS-omega/kappa peptide HXTXHvla, pyrazole, pyrethroids and pyrethrins, pyridalyl, pyriproxyfen, propargite, quinomethion ato, rotenone, semicarbazones, fluoroaliphatic sulfonamide, sulfoxaflor, tetradiphone or the like.

In the embodiment in which the at least one pesticidal active ingredient is a nematicide, a nematicide is an ingredient comprising at least one of the following chemical classes: halogenated aliphatic, avermectin, benzamides, plant extract, fluoroalkenyle (-thiother), isothiocyanate precursor of methyl, benzofuranyl methylcarbamate, organophosphate or the like.

In the embodiment in which the at least one pesticidal active ingredient is a plant growth regulating compound, plant growth regulators are understood to be those comprising one or more of the following compounds: dioxocyclohexanecarboxylic acid, indolealkanoic acid, aliphatic alcohol, quaternary ammonium, carbimide, carboxanilide, cycloalkene, cyclohexadione, cytokinin, dinitroaniline, ethylene inhibitor, ethylene precursor, gibberellin, pyridazinedione, sesquiterpenes, triazole, benzothiadiazole, nitric oxide, methyl salicylate, methyl jasmonate, proteins, polypeptides, polyamines, algae extracts, fulvic acid, humic acid, plant growth promoting rhizobacteria, or the like.

In the embodiment in which the at least one pesticidal active ingredient is a phytotoxicity-reducing compound, toxicity-reducing compounds are understood to be those that comprise one or more of the following compounds: benoxacor, 1-bromo-4-[chloro(methanesulfonyl)]benzene, cloquintocet-methyl, cyometrinyl, cyprosulfamide, dichlormid, dicyclonone, dietolate, fenchlorazole, fenclorim, flurazol, fluxophenim, furilazole, isoxadifen, jiecaowan, jiecaoxi, mefenpyr, mephenate, metcamifen, phthalic anhydride, oxabetrinyl, or the like.

In one embodiment, the agrochemical composition may further comprise at least one additional organic solvent that is not fully soluble in water. The at least one additional solvent may be selected from the group of chemical classes consisting of esters, amides, ketals, ethers, carbonates, lactones and hydrocarbons.

The at least one pesticidal active ingredient may be present in the agrochemical composition at a concentration of from about 0.1% to about 95% w/v, based on the total volume of the composition. Preferably, the at least one pesticidal active ingredient is present in a concentration of from about 10% to about 90% w/v, or in a concentration of from about 25% to about 85% w/v.

In an alternative embodiment, the agrochemical composition may comprise one or more optional components such as water, adjuvants, surfactants, preservatives, emulsifiers, defoamers, antifreezes, stabilizers, crystallization inhibiting agents, or the like.

Emulsifiers for use in the agrochemical composition may include, but are not limited to, anionic, nonionic, polymeric surfactants and mixtures thereof. Among the anionic surfactants are aryl or alkylarylbenzenesulfonate salts (optionally calcium and sodium salts of dodecylbenzenesulfonate, Ca/Na DDBS), sulfosuccinates, phosphate esters. Among the nonionics are alkoxylated alcohols, alkoxylated phenol derivatives, including, but not limited to, alkoxylated alkylphenol and/or alkoxylated tristyrylphenol, alkyl glucosides, alkoxylated castor oil, and other alkoxylated vegetable oils. Representatives of polymeric emulsifiers include, but are not limited to, copolymers of ethylene oxide and propylene oxide, polymers of acrylic acid, polyvinyl alcohol, and combinations thereof.

The emulsifier, if present in the composition, may be added in sufficient concentration to, when mixed with water, form and stabilize an emulsion. This agent may be present in amounts between about 1% and about 25% w/v based on the total volume of the composition. Preferably, the emulsifier is present in concentrations between about 3% and about 15% w/v.

The other optional components, if present in the composition, may be in total concentrations of up to about 30% w/v, preferably up to about 20% w/v, based on the total volume of the composition.

The present disclosure also relates to an agrochemical formulation comprising the agrochemical composition described above. The agrochemical formulation is preferably selected from the group comprising liquid formulation of the type of soluble concentrate (SL), oil dispersion formulation (OD), liquid formulation of the type of emulsifiable concentrate (EC), concentrated aqueous emulsion (EW) and in the form of capsule suspension (CS).

SL-type liquid formulations are formulations that readily dissolve in water. Thus, in such embodiments, the agrochemical composition comprising the at least one pesticidal active ingredient and the solvent based on a dioxabicycloalkane derivative is dissolved in water, thus forming a homogeneous solution without precipitates.

OD-type formulations are stable suspensions of the agrochemical composition as described above in a water-immiscible fluid.

EC-type formulations are liquid formulations intended for further mixing with water, in which a spontaneous emulsion is formed, while EW-type formulations are already stabilized emulsions of a water-insoluble organic liquid in a continuous aqueous phase. Then, in these embodiments, the agrochemical composition of the formulation comprises the at least one pesticidal active ingredient, the solvent based on a dioxabicycloalkane derivative, the at least one additional organic solvent, in addition to being able to contain at least one surfactant or emulsifier in order to facilitate the formation/stabilization of emulsions.

Capsule suspension (CS) formulations comprise the agrochemical composition, as described above, encapsulated in a polymeric casing, wherein for final application the capsule will be further diluted or formed in water in the spray tank.

In an alternative embodiment, the solvent based on a dioxabicycloalkane derivative can be the solvent or a co-solvent of the solvent system responsible for the solubilization of the polymer and its subsequent controlled precipitation forming the polymeric shell (capsule). Thus, in this embodiment, it is possible to form self-encapsulated systems, in which the dioxabicycloalkane derivative is used both as a solvent for at least one pesticide active ingredient in the agrochemical composition, and as a solvent/co-solvent for the polymeric system that forms the capsule, replacing the use of organic solvents with a high degree of toxicity and/or flammability.

The present disclosure also relates to the use of dioxabicycloalkane derivatives in agriculture.

Particularly, the use of dioxabicycloalkane derivatives is as a solvent in an agrochemical formulation as described above.

In the context of the present disclosure, “solvent” is understood to mean a compound that has the ability to solubilize at least one pesticidal active ingredient of interest, or even a compound that has the ability to compatibilize a system comprising hydrophilic and hydrophobic compounds without phase separation or active ingredient crystallization occurs.

Therefore, the present disclosure reflects the observation that dioxabicycloalkane derivatives, such as dihydrolevoglucosenone, are able to act as a hydrotope (or electrolyte compatibilizer) compound in systems comprising hydrophobic and hydrophilic components.

As already mentioned, the dioxabicycloalkane derivative is selected from the group comprising a dioxabicyclo[3.2.1]octane, dioxabicyclo[2.2.2]octane, dioxabicyclo[3.3.2]decane, dioxabicyclo[4.2.2]decane, dioxabicyclo[4.3.1]decane, dioxabicyclo[3.3.3]undecane, dioxabicyclo[5.2.1]decane, dioxabicyclo[4.4.1]undecane, dioxabicyclo[4.3.2]undecane, dioxabicyclo[5.3.1]undecane, or their derivatives or mixtures thereof.

Preferably, the dioxabicycloalkane derivative is a dioxabicyclo[3.2.1]octane derivative, and more preferably, it is 6,8-dioxabicyclo[3.2.1]octan-4-one or dihydrolevoglucosenone.

In a particular embodiment, the use of dioxabicycloalkane derivatives is as a solvent or a co-solvent in polymeric encapsulation systems. Thus, the dioxabicycloalkane derivative can act both in the solubilization of the polymer of the polymeric system that forms the capsule, and in the solubilization of the pesticidal active ingredient to be encapsulated, or in both systems.

In an alternative embodiment, in addition to the solvent function, the dioxabicycloalkane derivative is also capable of acting as an active ingredient penetration and uptake promoter in plant parts, such as leaves, roots or seeds.

Penetration of the active ingredient occurs through the plant cuticle and the penetration enhancement effect is known and has been reported for different chemical classes, such as alkoxylated alcohols, alkoxylated alcohol esters, vegetable oil esters, fatty acid amides, polyglycosides, oligosaccharides, and alkyl phosphates, as described in patent documents PCT/EP2007/010643, PCT/GB2013/053043, EP1993110538, and PCT/NZ2010/000182.

The cuticle that is present on the plant surface is covered by a layer of hydrophobic wax that tends to repel substances with a high hydrophilic character, however, surprisingly, it was observed that despite being highly hydrophilic, the dioxabicycloalkane derivative acts as a penetration promoter and it can be included in the agrochemical composition as described above from before its dilution (“in-can” mixture) or it can be added after dilution of a ready-made agrochemical formulation, being incorporated into the spray mixture as a tank mix adjuvant.

Furthermore, the present disclosure also relates to a method for treating and/or preventing diseases or pests in a plant or plant seed. Said method comprises applying the agrochemical formulation described herein, after dilution, directly to at least part of said plant or plant seed, or applying it directly to the soil.

The description that follows will start from preferred embodiments of the invention. As it will be clear to one skilled in the art, the invention is not limited to such particular embodiments.

### EXAMPLES

### Example 1—Solvency and Toxicology Data

To illustrate the greater efficiency of the disclosed embodiments, 6 (six) agrochemical compositions were prepared, each comprising a different pesticidal active ingredient among herbicides, fungicides, insecticides, and phytotoxicity reducers. Active ingredients tested include the following compounds: mesotrione, azoxystrobin, prothioconazole, tebuconazole, imidacloprid, and isoxadifen.

The solvent derived from dioxabicycloalkane used in the tested compositions was 6,8-dioxabicyclo[3.2.1]octan-4-one or dihydrolevoglucosenone.

In Table 1, below, the solvency data can be seen, i.e. the maximum amount of active ingredient per liter of solvent of the compositions prepared (amount in gram of active ingredient solubilized per liter of solvent), as well as solvency data for three solvents commonly used in the agrochemical market, namely: N-methyl pyrrolidone, γ-butyrolactone, and N,N-dimethylamide (C₈-C₁₀).

TABLE 1
Agrochemical compositions prepared

| | Dihydrolevoglu- | N- | γ- | N,N- |
|---|---|---|---|---|
| Active | cosenone | methylpyrrolidone | butyrolactone | dimethylamide |
| ingredient | (g/L) | (NMP) (g/L) | (g/L) | (C₈-C₁₀) (g/L) |
| Mesotrione | 300 | 400 | 300 | <100 |
| Azoxystrobin | 800 | 900 | 800 | 100 |
| Imidacloprid | 300 | 600 | 300 | <100 |
| Prothioconazole | 400 | 1100 | 900 | 600 |
| Tebuconazole | 300 | >200 | >200 | Not assessed |
| Isoxadifen | 400 | Not assessed | Not assessed | Not assessed |

The above compositions were prepared at a temperature of about 50° ° C. stirred with a vortex mixer until visual inspection indicated the absence of solids, confirming solubilization of the active ingredient in the solvent.

Thus, comparing the data presented in Table 1, it is evident that dihydrolevoglucosenone has an excellent solvency power that is equivalent, or even better in some cases, to the comparative solvents commonly used in agrochemical formulations.

The active ingredient azoxystrobin was chosen to carry out an additional test of crystallization of the active ingredient upon dilution in water. It was selected a dilution in the ratio of 1:20 between solution (containing 100 g/L of AI) and water for different solvents, taking into account miscibility with water and polarity, based on log P values. Among the solvents chosen for evaluation are the solvents dihydrolevoglucosenone, γ-butyrolactone, N-methylpyrrolidone, and triacetin. Table 2 presents solvent properties and behavior upon dilution of the azoxystrobin solution in water.

TABLE 2
Test results of dilution of azoxystrobin
solution in different solvents

| | | Miscibility | Observation |
|---|---|---|---|
| Solvent | logP | with water | by dilution |
| Dihydrolevoglucosenone | −1.52 | Miscible | Two-phase |
| | | | formation |
| γ-butyrolactone | −0.60 | Miscible | Immediate |
| | | | crystallization |
| N-methylpyrrolidone | −0.40 | Miscible | Immediate |
| | | | crystallization |
| Triacetin | 1.30 | Immiscible | Two-phase |
| | | | formation |

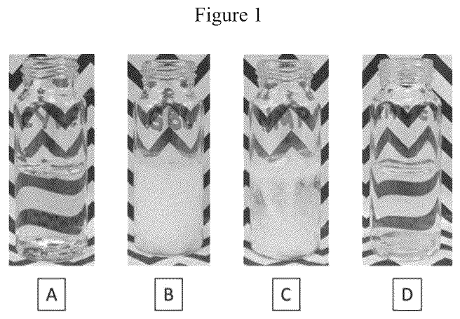

FIG. 1 shows the test vials immediately after diluting the azoxystrobin solution in water.

In Table 3, below, information regarding the toxicology of dihydrolevoglucosenone and those same comparative solvents can be seen.

TABLE 3
Toxicology of different solvents

| | | | | dihydrolevoglu- |
|---|---|---|---|---|
| Property | NMP | Dimethylamide | lactone | cosenone |
| Skin irritation | 2 | 2 | — | — |
| Eye irritation | 2A | 1 | 1 | 2A |
| Respiratory tox. | 3 | 3 | — | — |
| Central nervous system tox. | — | — | 3 | — |
| Reproductive system tox. | 1B | — | — | — |
| Aquatic environment tox. | — | 2 | 3 | — |

Toxicity parameters were obtained from chemical safety data sheets (FISPQ), where number 1 represents the worst result (danger), number 4 represents the mildest result and hyphens (-) represent absence of toxicity for that parameter.

In Table 4, below, the data regarding the phytotoxicity observed for dihydrolevoglucosenone and the comparative solvents can be observed, represented as percentage of damage observed in each leaf after 24 h of exposure.

TABLE 4
Phytotoxicity data observed for the solvents commonly used
in the agrochemical market and the present embodiment.

| | | | | dihydrolevoglu- |
|---|---|---|---|---|
| | NMP | Dimethylamide | Lactone | cosenone |
| Phytotoxicity | 42 | 93 | 27 | 6 |
| (damage %) | | | | |

Phytotoxicity data were generated in tests on Poinsettia (red leaves plant), since this leaf is sensitive to damage caused by chemical agents, which makes it possible to verify and compare the tested solvents.

Therefore, from the information contained in Tables 3 and 4, it is possible to conclude that, in addition to the high solvency power already proven by Table 1, dihydrolevoglucosenone also has the benefit of having a better toxicological and ecotoxicological profile when compared to the benchmarks.

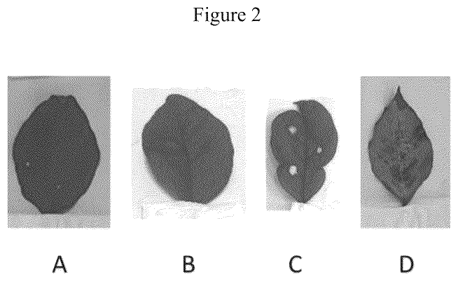

It can be seen in FIG. 2 the leaves used for phytotoxicity test 24 hours after application of the droplets with the damage caused by the solvents as reported in Table 4. The leaves represented by the letter A corresponds to the test carried out with dihydrolevoglucosenone, B corresponds to γ-butyrolactone, C corresponds to N-methylpyrrolidone and D corresponds to N,N-dimethylamide C8-C10.

### Example 2—Encapsulated Formulations

Agrochemical composition A was prepared in the form of an emulsifiable concentrate (EC), comprising prothioconazole as active ingredient, dihydrolevoglucosenone as the solvent derived from dioxabicycloalkanes, additional solvents based on esters derived from natural alcohols, emulsifiers, and stabilizer, as described in Table 5. SURFOM® and ALKEST® branded products are commercially available from Oxiteno.

TABLE 5
Composition A

| Component | Amount (g/L) |
|---|---|
| Prothioconazole | 280 |
| Dihydrolevoglucosenone | 110 |
| SURFOM CE 8115 | 245 |
| SURFOM EMS 2000 | 280 |
| SURFOM CE 2115 | 50 |
| SURFOM 1432 EC | 50 |
| SURFOM R360 | 50 |
| 2-ethyl hexyl alcohol | 50 |

To prepare the formulation in encapsulated form, agrochemical composition A described above, a polymer, a solvent system comprising water and acetone, as well as a dispersing/solubilizing agent, as shown in Table 6, were used.

TABLE 6
Components used in the preparation
of the CS agrochemical formulation

| Component | Amount (g) |
|---|---|
| Copolymer ((meth)acrylic | 0.1 |
| acid/methyl(meth)acrylate) | |
| Acetone | 23.7 |
| Water | 30 |
| Alkest TW-80 | 0.06 |
| Composition A | 0.25 |

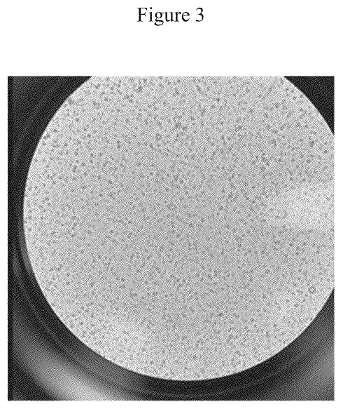

It can be seen in FIG. 3 a microscopy image with the presence of spherical morphology capsules that refer to the CS formulation containing composition A.

### Example 3—Performance as a Penetration Promoter

The agrochemical composition B, detailed in Table 7, was applied in the form of an EC formulation in plants of the species Euphorbia heterophylla (Euphorbiaceae). The influence on pest control was observed, being also compared with SC formulation based on commercially available mesotrione and free of a dioxabicycloalkanes derivative in its composition.

TABLE 7
Composition B

| Component | Amount (g/L) |
|---|---|
| Mesotrione | 480 |
| SURFOM CE 8056 | 80 |
| Solvent | q.s. 1 L |

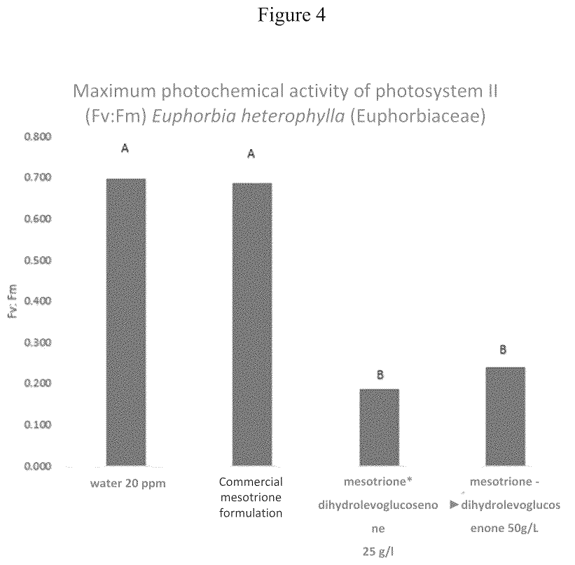

Two EC-type formulations containing composition B above were prepared and tested using dioxabicycloalkane derivatives added at concentrations of 25 and 50 g/L, the results being shown in the graph of FIG. 4. The test performed to verify the herbicidal activity is based on chlorophyll fluorescence parameters, where Fv means variable fluorescence and Fm means maximum fluorescence, so the Fv/Fm ratio represents the potential efficiency of the system, as described in the work by Barker, published in Annu magazine. See Plant Biol. 2008, 59, 89. When the Fv/Fm ratio is maximum, the system is at the peak of its efficiency, however, when this ratio is minimal, photosynthesis does not occur efficiently, indicating plant death. This reduction in the Fv/Fm ratio is proportional to the active concentration that penetrates the leaf blade.

Therefore, as can be seen in FIG. 4, the Fv/Fm values of the formulations that contain dihydrolevoglucosenone in their composition are lower in the graph compared to the commercially available formulation that comprises other types of solvents, indicating an improvement in the penetration of the active ingredient by the plant leaf to be treated.

The description that has been made so far of the object of present invention should be considered only as a possible embodiment(s), and any particular characteristics introduced therein should be understood only as something that has been described to facilitate understanding. Accordingly, they can in no way be considered as limiting the invention, which is limited to the scope of the claims which follow.

1-22. (canceled)

23. An agrochemical composition, comprising:
i) at least one pesticidal active ingredient, wherein the at least one pesticide active ingredient is selected from the group consisting of herbicides, fungicides, insecticides, nematicides, phytotoxicity reducers and plant growth regulators; and
ii) a solvent based on a dioxabicycloalkane derivative, wherein the dioxabicycloalkane derivative is selected from the group consisting of dioxabicyclo[3.2.1]octane, dioxabicyclo[2.2.2]octane, dioxabicyclo[3.3.2]decane, dioxabicyclo[4.2.2]decane, dioxabicyclo[4.3.1]decane, dioxabicyclo[5.2.1]decane, dioxabicyclo[3.3.3]undecane, dioxabicyclo[4.3.2]undecane, dioxabicyclo[4.4.1]undecane, dioxabicyclo [5.3.1]undecane, derivatives thereof, and mixtures thereof;
iii) one or more emulsifiers selected from the group consisting of anionic, nonionic, polymeric surfactants and mixtures thereof,
wherein the anionic surfactant is selected from the group consisting of aryl or alkylarylbenzenesulfonate salts, sulfosuccinates, and phosphate esters;
wherein the nonionic surfactant is selected from the group consisting of alkoxylated alcohols, alkoxylated phenol derivatives, alkyl glucosides, and alkoxylated vegetable oils;
wherein the polymeric surfactant is selected from the group consisting of ethylene oxide, propylene oxide, acrylic acid polymers, polyvinyl alcohol, and combinations thereof.

24. The agrochemical composition according to claim 23, wherein the dioxabicycloalkane derivative is a dioxabicyclo[3.2.1]octane derivative selected from 2,8-dioxabicyclo[3.2.1]octane, 2,8-dioxabicyclo [3.2.1]octan-4-one, 2,8-dioxabicyclo[3.2.1]octan-4-thione, 4-methylidene-2,8-dioxabicyclo[3.2.1]octane, 1-methyl-2,8-dioxabicyclo[3.2.1]octan-7-one, 1,4,4-trimethyl-2,8-dioxabicyclo[3.2.1]octan-7-one, 1,3,5-trimethyl-2,8-dioxabicyclo[3.2.1]octan-7-one, 1-methyl-4-phenyl-2,8-dioxabicyclo[3.2.1]octan-7-one, 1-methyl-4-phenyl-2,8-dioxabicyclo[3.2.1]oct-7-yl acetate, 6,8-dioxabicyclo[3.2.1]octane, 6,8-dioxabicyclo[3.2.1]octan-4-thione or 6,8-dioxabicyclo[3.2.1]octan-4-one or mixtures thereof.

25. The agrochemical composition according to claim 24, wherein the dioxabicyclo[3.2.1]octane derivative is 6,8-dioxabicyclo[3.2.1]octan-4-one.

26. The agrochemical composition according to claim 23, wherein the at least one pesticidal active ingredient is a herbicide comprising at least one chemical class selected from the group consisting of: acetamides, arylaminopropionic acid, benzoic acid, chlorocarbonic acid, phenoxycarboxylic acid, phosphinic acid, quinolinecarboxylic acid, amides, aryloxyphenoxypropionates (FOPs), arylpicolinate, benzamides, benzofurans, benzothiadiazinones, bipyridyliums, carbamates, cyclohexanediones (DIMs), chloroacetamides (V1), chloroacetamides (V2), chloroacetamides (V3), diphenyl ethers, dinitroanilines, dinitrophenols, phenylcarbamates, phenylpyrazoles, phenylpyrazolines (DENs), phenylpyridazines, phosphoroamidates, phosphorodithioates, phthalamates, semicarbazones, glycines, imidazolinones, long-chain fatty acid inhibitor, N-phenylphthalimides, nitriles, isoxazoles, isoxazolidinones, organoarsenicals, oxadiazoles, oxazolidinediones, oxyacetamides, pyrazoles, pyrazolines, pyridazinones, pyridines, pyridinecarboxamides, pyrimidindiones, pyrimidinyl(thio)benzoates, sulfonylaminocarbonyl-triazolinones, sulfonylureas, tetrazolinones, thiadiazoles, thiocarbamates, triazines, triazinones, triazoles, triazolinones, triazolocarboxamides, triazolopyrimidines, triketones, uracils, and ureas.

27. The agrochemical composition according to claim 23, wherein the at least one pesticidal active ingredient is a fungicide comprising at least one chemical class selected from the group consisting of: 1,2,4-thiadiazole, 2,6-dinitro-aniline, 4-quinolyl acetate, carboxylic acid, enopyranuronic acid, phthalamic acid, acylalanine, allylamine, mandelic acid amides, cinnamic acid amides, aminocyanoacrylate, amino-pyrazolinone, anilinopyrimidine, anthraquinone, aryloxyquinoline, Bacillus sp. and the fungicide lipopeptides produced, benzene sulfonamide, benzyl carbamate, benzimidazole, benzisothiazole, benzophenone, benzoylpyridine, benzothiadiazole BTH, benzotriazine, butyrolactone, carbamate, carboxamide, cyanoacetamide oxime, cyano-imidazole, cyano-methylene-thiazolidine, cyclopropane carboxamide, chloronitrile, triphenyltin compounds, dicarboximide, dihydro-dioxazine, dinitrophenyl crotonate, dithiocarbamates and relatives, dithiolane, spiroketal-amine, ethyl phosphonate, ethylamino-thiazole-carboxamide, phenyl-acetamide, phenyl-benzamide, phenyl-oxo-ethyl thiophene amide, phenylpyrrole, phenylurea, phosphonate, phosphorothiolate, phthalimide, furan-carboxamide, guanidine, aromatic hydrocarbon, terpenic hydrocarbons and terpenic alcohols, hydroxy-(2-amino-)pyrimidine, hydroxyaniline, imidazole, imidazolinone, inorganic (copper), inorganic (sulfur), isobenzofuranone, isothiazolone, isoxazole, maleimide, methoxy-acetamide, methoxy-acrylate, methoxy-carbamate, Reynoutria sp. extract, morpholine, N-phenyl carbamate, N-methoxy-(phenyl-ethyl)-pyrazole-carboxamide, peptidyl pyrimidine nucleoside, oxatin-carboxamide, oxazolidine-dione, oxazolidinone, oximino-acetamide, oximino-acetate, piperazine, piperidine, piperidinyl-thiazole-isoxazoline, pyrazole-4-carboxamide, pyrazole-5-carboxamide, pyridazinone, pyridine, pyridine-carboxamide, pyridinyl-ethyl benzamide, pyridinylmethyl-benzamide, pyrimidine, pyrimidinamine, pyrimidinone-hydrazone, pyrrolo-quinolinone, polypeptide (lectin), polysaccharide, propionamide, quinazolinone, quinoxaline, sulfamoyl-triazole, sulfonamide, tetrazoyloxime, thiadiazole-carboxamide, thiazole-carboxamide, thiocarbamate, thiophanate, thiophene-carboxamide, toluamide, triazine, triazole, triazolinthione, triazolobenzothiazole, triazole-pyrimidylamine, Trichoderma sp. and fungicidal metabolites produced, trifluoroethylcarbamate, and valinamide carbamate.

28. The agrochemical composition according to claim 23, wherein the at least one pesticide active ingredient is an insecticide comprising at least one chemical class selected from the group consisting of: METI group of acaricides and insecticides, acequinocyl, halogenated aliphatic, amitraz, nereistoxin analogues, juvenile hormone analogues, avermectins, milbemycins, azadirachtin, Bacillus sp. and produced insecticidal proteins, benzoylureas, benzoximate, biphenazate, borates, borax, bromopropylate, buprofezin, butenolides, sulfocalcium syrup, carbamates, carboxanilides, cyanides, cyclodienes, cyromazine, clofentezine, diflovidazin, hexithiazoxy, chlorfenapyr, dinitrophenol, sulfluramid, chloropicrin, DDT methoxychlor, tetronic and tetramic acid derivatives, beta-ketonitrile derivatives, azomethine pyridine derivatives, diacylhydrazines, diafenthiuron, diamides, dicofol, spinosyns, ethoxazole, phenylpyrazoles (fiproles), phenoxycarb, saponin flavones of the rotenoid type, flonicamide, fluacripyrim, fluorides, phosphides, methyl isothiocyanate generators, hydramethylnonone, inorganic, inorganic phosphine precursor, methyl isothiocyanate precursor, organophosphate, mesoionic, neonicotinoid, nicotine, organotin, organophosphate, oxadiazines, GS-omega/kappa peptide HXTXHvla, pyrazole, pyrethroids and pyrethrins, pyridalyl, pyriproxyfen, propargite, quinomethion ato, rotenone, semicarbazones, fluoroaliphatic sulfonamide, sulfoxaflor, and tetradiphone.

29. The agrochemical composition according to claim 23, wherein the at least one pesticidal active principle is a nematicide comprising at least chemical class selected from the group consisting of: halogenated aliphatic compound, avermectin, benzamides, plant extract, fluoroalkenyle (-thiother), methyl isothiocyanate precursor, benzofuranyl methylcarbamate, and organophosphate.

30. The agrochemical composition according to claim 23, wherein the at least one pesticidal active ingredient is a plant growth regulator compound that comprises one or more of the compounds selected from the group consisting of: dioxocyclohexanecarboxylic acid, indolealkanoic acid, aliphatic alcohol, ammonium quaternary, carbimide, carboxanilide, cycloalkene, cyclohexadione, cytokinin, dinitroaniline, ethylene inhibitor, ethylene precursor, gibberellin, pyridazinedione, sesquiterpenes, triazole, benzothiadiazole, nitric oxide, methyl salicylate, methyl jasmonate, proteins, polypeptides, polyamines, algae extracts, fulvic acid, humic acid, and plant growth promoting rhizobacteria.

31. The agrochemical composition according to claim 23, wherein the at least one pesticidal active ingredient is a phytotoxicity-reducing compound selected from the group consisting of benoxacor, 1-bromo-4-[chloro(methanesulfonyl)] benzene, cloquintocet-methyl, cyometrinyl, cyprosulfamide, dichlormid, dicyclonone, dietolate, fenchlorazole, fenclorim, flurazol, fluxphenim, furilazole, isoxadifen, jiecaowan, jiecaoxy, mefenpyr, mefenate, metkamifen, phthalic anhydride, and oxabetrinyl.

32. The agrochemical composition according to claim 23, wherein the agrochemical composition further comprises at least one additional organic solvent selected from the group of chemical classes consisting of esters, amides, ketals, ethers, carbonates, lactones, and hydrocarbons.

33. The agrochemical composition according to claim 23, wherein the at least one pesticidal active ingredient is present in a concentration of from about 0.1% to about 95% w/v, based on the volume of the composition.

34. The agrochemical composition according to claim 23, wherein the agrochemical composition further comprises one or more optional components selected from the group consisting of water, adjuvants, surfactants, preservatives, defoamers, antifreeze, stabilizers, and crystallization inhibiting agents.

35. The agrochemical composition according to claim 34, wherein the one or more optional components are present in the agrochemical composition in a concentration of up to about 30% w/v, based on the total volume of the composition.

36. An agrochemical composition according to claim 23, wherein the at least one pesticidal active ingredient is present in a concentration of from about 10% to about 90% w/v, based on the volume of the composition.

37. The agrochemical composition according to claim 23, wherein the emulsifier is present in the agrochemical composition in a concentration ranging from about 1% to about 25% w/v, based on the total volume of the composition.

38. An agrochemical formulation, comprising the agrochemical composition of claim 23,
wherein the agrochemical formulation is selected from the group consisting of a liquid formulation of the type of soluble concentrate (SL), an oil dispersion formulation (OD), a liquid formulation of the type of emulsifiable concentrate (EC), concentrated aqueous emulsion (EW), in capsule suspension form (CS), or mixtures thereof.

39. The agrochemical formulation according to claim 38, wherein the agrochemical formulation is a formulation in encapsulated form, in which the dioxabicycloalkane derivative is also used as a solvent or co-solvent of the polymeric system that forms the capsule.

40. The agrochemical formulation, comprising the agrochemical composition of claim 38, wherein the agrochemical formulation is a CS and SC mixture (ZC), a CS and EW mixture (ZW) or a mixture of CS and SE (ZE).

41. A method for the treatment and/or prevention of diseases or pests in a plant or plant seed, comprising:
applying the agrochemical formulation of claim 38 directly to at least part of said plant or seed plant, or applying the agrochemical formulation directly to the soil.

42. A method for the treatment and/or prevention of diseases or pests in a plant or plant seed, comprising:
applying the agrochemical formulation of claim 39 directly to at least part of said plant or seed plant, or applying the agrochemical formulation directly to the soil.

43. A method for the treatment and/or prevention of diseases or pests in a plant or plant seed, comprising:
applying the agrochemical formulation of claim 40 directly to at least part of said plant or seed plant, or applying the agrochemical formulation directly to the soil.
